(19) United States
(12) Patent Application Publication
(10) Pub. No.: US 2013/0179521 A1
(43) Pub. Date: Jul. 11, 2013

(54) METHOD AND DEVICE FOR IMPLEMENTING A GROUP SESSION

(71) Applicant: Huawei Technologies Co., Ltd., Shenzhen (CN)

(72) Inventor: Hanqiang Hu, Shenzhen (CN)

(73) Assignee: Huawei Technologies Co., Ltd., Shenzhen (CN)

(21) Appl. No.: 13/782,577

(22) Filed: Mar. 1, 2013

Related U.S. Application Data
(63) Continuation of application No. PCT/CN2011/074942, filed on May 31, 2011.

(30) Foreign Application Priority Data
Sep. 1, 2010 (CN) 201010269137.9
Dec. 24, 2010 (CN) 201010606160.2

(51) Int. Cl. H04L 12/58

(52) U.S. Cl. CPC H04L 51/04
USPC 709/206

(57) ABSTRACT

The embodiments of the present invention disclose a method and a device for implementing a group session, relating to communication technologies, for implementing a CPM/IM message group session based on signalling. The method for implementing a group session comprises: receiving a group message that is sent by a terminal participating in a message group session, the group message carrying a session serial number corresponding to the message group session; and sending the group message carrying the session serial number to other terminals participating in the message group session corresponding to the session serial number. The solution in the embodiments of the present invention is well suited for performing a group session via messages.

### CROSS-REFERENCE TO RELATED APPLICATIONS

This application is a continuation of International Patent Application No. PCT/CN2011/074942 filed on May 31, 2011, which claims priority to Chinese Patent Application No. 201010269137.9 filed on Sep. 1, 2010, and Chinese Patent Application 201010606160.2 filed on Dec. 24, 2010, all of which are hereby incorporated by reference in their entireties.

### FIELD OF TECHNOLOGY

The present invention relates to communication technologies, and more particularly, to a method and a device for implementing a group session.

### BACKGROUND

IP based CPM (Converged IP Messaging) is a new message service framework. The Converged IP Messaging merges universal functions of current message services and is capable of providing communication business based on SIP (Session Initiation Protocol).

For the moment, OMA (Open Mobile Alliance) defines a technical specification about CPM/IM (Instant Messaging), where the CPM/IM is able to support a group session function so as to realize synchronous communication between multiple mobile users.

Specifically, after multiple user terminals that participate in a group session establish a group session communication with a CPM/IM server, the multiple user terminals establish MSRP (Message Session Relay Protocol) media channels with the CPM/IM server according to SDP (Session Description Protocol) information of the respective user terminal, and implement a group session between multiple user terminals via the MSRP media channels, where the SDP information is as a user terminal's IP address, the user terminal's port number or media type supported by the user terminal and so on.

However, in the process of implementing the above-described CPM/IM group session, the inventor found that at least the following problems exist in the prior art.

The above-mentioned CPM/IM group session is carried by media channels based on TCP (Transmission Control Protocol) long connection, which will occupy media channel resources, and a server is needed to reserve and maintain corresponding media channel resources for the above-mentioned CPM/IM group session; meanwhile, as the media channel occupied by the above-mentioned CPM/IP group session is the one that the server assigned separately for each terminal participating the group session after the group session is established, the utilization of media channel resources is declined.

### SUMMARY OF THE INVENTION

The embodiments of the present invention provide a method and a device for implementing a group session to improve the utilization of channel resources.

In order to achieve the above-mentioned purpose, the embodiments of the present invention adopt the following technical solutions.

A method for implementing a group session includes:

receiving a group message that is sent by one terminal participating in a message group session, wherein the group message carries a session serial number corresponding to the message group session; and

sending the group message carrying a session serial number to other terminals participating in the message group session corresponding to the session serial number.

A method for implementing a group session includes:

sending a group message to a group session server, the group message carrying a session serial number corresponding to the current message group session; and/or

receiving another group message, which is forwarded by the group session server, from other terminals participating in the message group session, the another group message carrying the session serial number corresponding to the current message group session.

A group session server includes:

a first receiver configured to receive a group message that is sent by a terminal participating in a message group session, the group message carrying a session serial number corresponding to the message group session; and

a first sender configured to send the group message which carries the session serial number to other terminals participating in the message group session corresponding to the session serial number.

A group session device includes:

a sender configured to send a group message to a group session server, wherein the group message carries a session serial number corresponding to the current message group session; and/or

a receiver configured to receive a group message, which is forwarded by the group session server, from other terminals participating in a message group session, wherein the group message carries the session serial number corresponding to the current message group session.

According to the method and the device for implementing a group session provided in the embodiments of the present invention, a message carries a session serial number, which indicates the message is a group message that corresponds to a group session; therefore, after identifying the message received by the group session server is a group message according to the session serial number, the group session server can simultaneously forward the group message to other terminals participating in the current message group session. With the above-described solution, the group message is enabled to be transferred via an ordinary communication channel that can be multiplexed by multiple users or multiple sessions without occupying a specific media channel, thereby increasing the comprehensive utilization of channels.

### BRIEF DESCRIPTION OF THE DRAWINGS

In order to describe the technical solution in the embodiments of the present invention or in the prior art more clearly, a brief introduction on the drawings which are needed in the description of the embodiments is given below. Obviously, the drawings in the description below are only some of the embodiments of the present invention, based on which other drawings can be obtained by those of ordinary skill in the art without any inventive efforts.

FIG. 1 is a flow chart of a method for implementing a group session according to Embodiment 1 of the present invention;

FIG. 2 is a diagrammatic drawing of an arrangement of a group session server according to Embodiment 1 of the present invention;

FIG. 3 is a flow chart of a method for implementing a group session according to Embodiment 2 of the present invention;

FIG. 4 is a diagrammatic drawing of an arrangement of a group session device according to Embodiment 2 of the present invention;

FIG. 5 is a flow chart of signalling of a method for implementing a group session according to Embodiment 3 of the present invention;

FIG. 6 is a flow chart of signalling of a method for implementing a group session according to Embodiment 4 of the present invention;

FIG. 7 is a flow chart of signalling of a method for implementing a group session according to Embodiment 5 of the present invention;

FIG. 8 is a flow chart of a configuration of a group session server according to Embodiment 8 of the present invention;

FIG. 9 is a flow chart of a configuration of a group session device according to Embodiment 9 of the present invention;

FIG. 10 is a flow chart of a configuration of a group session system according to Embodiment 10 of the present invention;

FIG. 11 is a flow chart of signalling of a method for implementing a group session according to Embodiment 6 of the present invention; and

FIG. 12 is a flow chart of signalling of a method for implementing a group session according to Embodiment 7 of the present invention.

### DETAILED DESCRIPTION OF THE EMBODIMENTS

The technical solution in the embodiments of the present invention is described hereinafter clearly and completely, with reference to the accompanying drawings in the embodiments of the present invention. Apparently, the described embodiments are only a part, but not all, of the embodiments of the present invention. All of the other embodiments that are obtained by those of ordinary skill in the art without any inventive efforts based on the embodiments in the present invention fall into the protection scope of the present invention.

A method, a device and a system for implementing a group session provided according to the embodiments of the present invention will be described in detail hereinafter with reference to the accompanying drawings.

### Embodiment 1

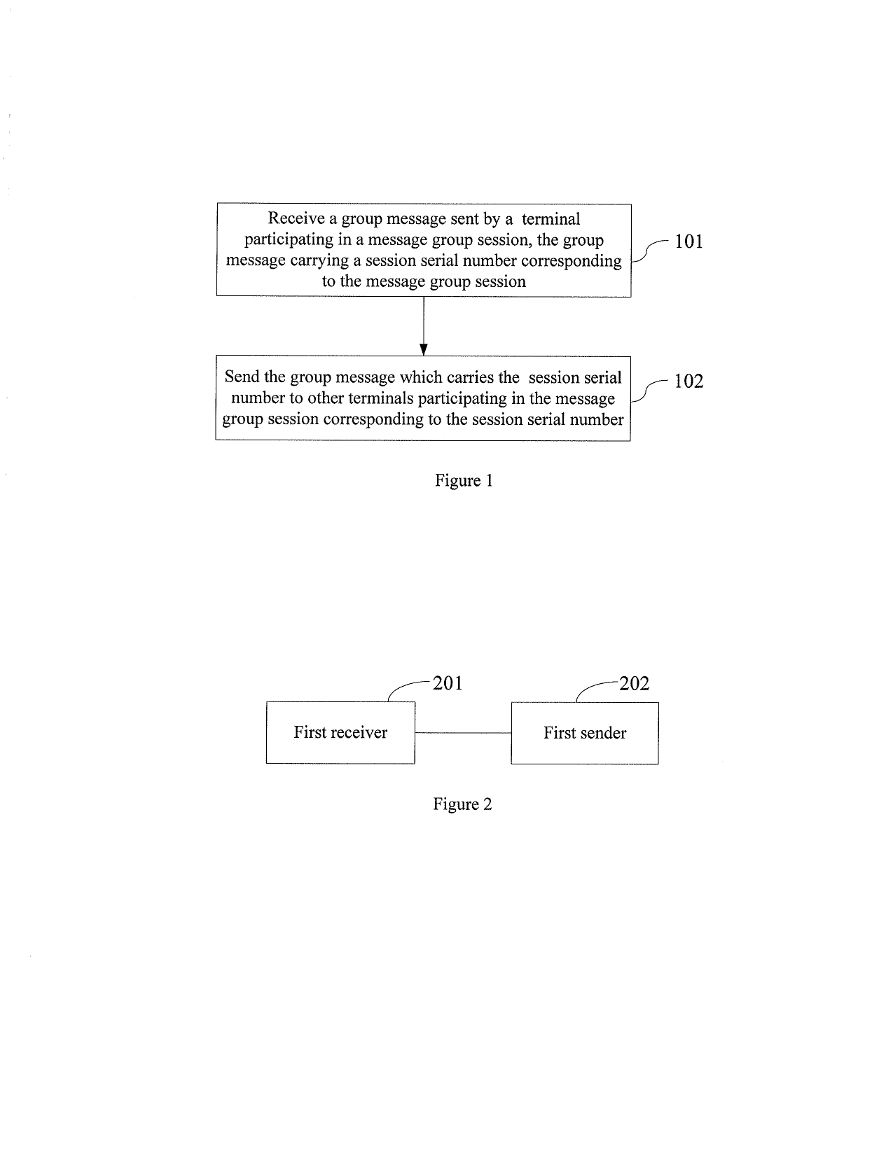

As depicted in FIG. 1, a method for implementing a group session provided according to the embodiments of the present invention, including the following:

101, a group message sent by a certain terminal participating in a message group session is received, the group message carrying a session serial number corresponding to the message group session.

The group message may, but not limited to, be a CPM/IM message; besides, the group message certainly may also be a message of other types, for example, the group message may be a group session message of Internet of Things Machine to Machine (M2M), an ordinary CPM/IM group session message, a group session message based on voice or a group session message based on multimedia and the like. The group session message of Internet of Things M2M may be a control command session message of Internet of Things M2M or a session message for an event read or reported by Internet of Things M2M, or data read or reported by Internet of Things M2M, the ordinary CPM/IM group session message may be a text message or a voice message, and the group session based on voice may be an ordinary voice conversation session or a Push to Talk over Cellular (POC) session and the like.

Further, the CPM/IM message may be a CPM/IM short message based on Message sigalling bearer.

The session serial number may be assigned for the message group session by a group session server when establishing the message group session. The specific operation may either assign a uniform session serial number for all the terminals participating in the group session; or assign a separate group session serial number for each of the terminal participating in the group session and then correlate the separate serial numbers of the terminals participating in the group session with each other. Of course, there also may be other manners available for acquiring the session serial number, and specific examples will not be listed herein.

102, the group message which carries the session serial number is sent to other g terminals participating in the message group session corresponding to the session serial number.

The group session server determines, according to the session serial number, that what is received currently is a group message, and meanwhile obtains it's message group session corresponding to the session serial number, and thus the group session server may forward the received group message to all of terminals participating in the group session except the group message sending terminal.

Generally, there are at least two terminals participating in the group session, so the above-described group session server needs to forward the group message to at least one of other terminal participating in the group session after receiving the group message.

In the above-mentioned description of the method, the executing object of the respective steps may be a group session server; and in conjunction with the practical practice, the executing object may be a CPM/IM server.

Corresponding to the above-described method for implementing a group session, the embodiments of the present invention also provide a group session server for implementing the above-described method. As described in FIG. 2, the group session server, including the following:

a first receiver 201, configured to receive a group message that is sent by a certain terminal participating in a message group session, the group message carrying a session serial number corresponding to the message group session; and

a first sender 202, configured to send the group message which carries a session serial number to other terminals participating in the message group session corresponding to the session serial number.

The embodiments of the present invention provide a method and a group session server for implementing the group session, in which a message carries a session serial number, which indicates the message is as a group message that corresponds to a certain group session, and therefore, after identifying the message received by the group session server is a group message according to the session serial number, the group session server can simultaneously forward the group message to other terminals participating in the current message group session. With the above-described solution, the group message is enabled to be transferred via an ordinary communication channel that can be multiplexed by multiple users or multiple sessions without occupying specific media channel, thereby increasing the comprehensive utilization of channels.

### Embodiment 2

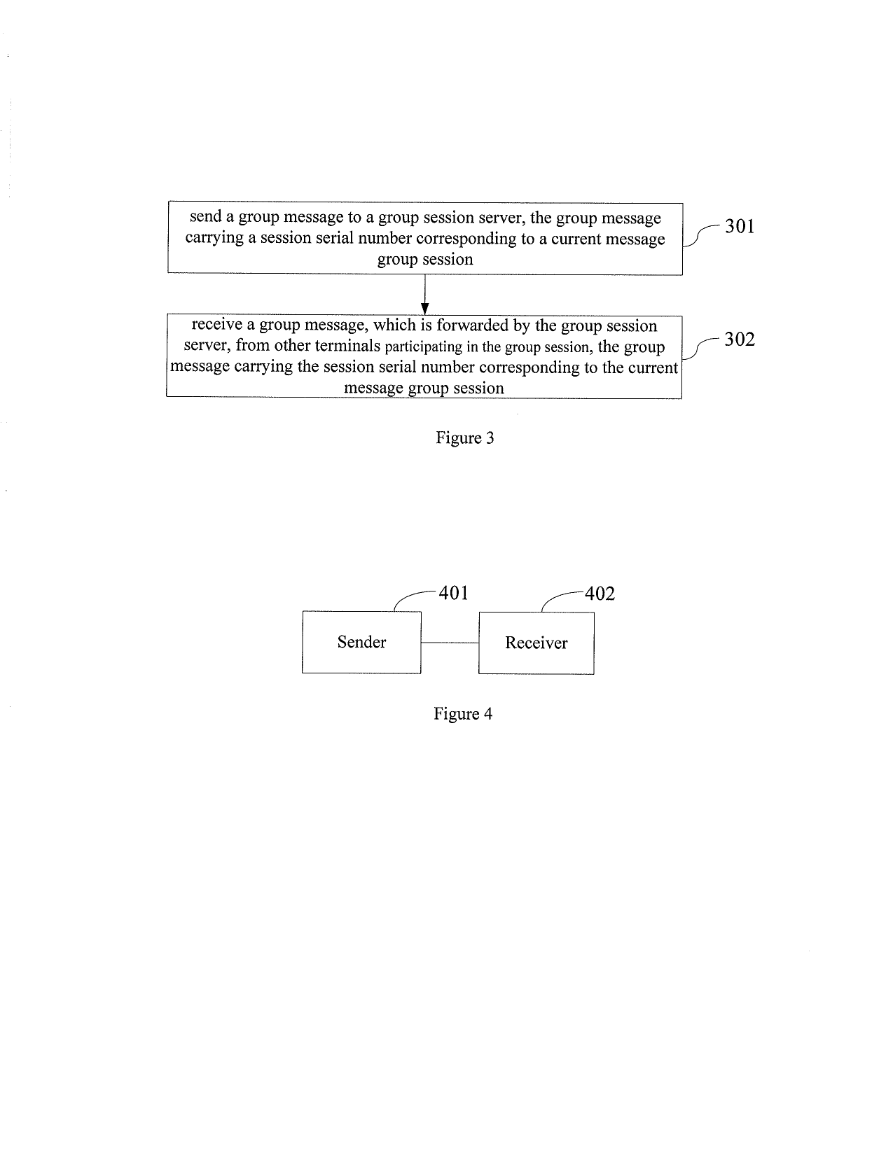

As illustrated in FIG. 3, the method for implementing a group session provided according to the embodiments of the present invention, including the following:

301, a group message is sent to a group session server, the group message carrying a session serial number corresponding to a current message group session; and/or

302, a group message, which is forwarded by the group session server, sent by other terminal participating in the group session to the group session server, is received, the group message carrying the session serial number corresponding to the current message group session.

The group message may, but not limited to, be a CPM/IM message; besides, the group message certainly may also be a message of other types, for example, the group message may be a group session message of Internet of Things Machine to Machine (M2M), an ordinary CPM/IM group session message, a group session message based on voice or a group session message based on multimedia and the like. The group session message of Internet of Things M2M may be a control command session message of Internet of Things M2M or a session message of an event read or reported by Internet of Things M2M, or data read or reported by Internet of Things M2M, the ordinary CPM/IM group session message may be a text message or a voice message, and the group session based on voice may be an ordinary voice conversation session or a Push to Talk over Cellular (POC) session message and the like.

Further, the CPM/IM message may be a CPM/IM short message based on Message sigalling bearer.

In the process of performing a normal message group session, the group message sent from a group session device to a group session server needs to carry a session serial number corresponding to the current message group session. As a result, after receiving the group message, the group session server determines, according to the session serial number thereof, what is received is a group message and obtains a group session corresponding to the group message.

In the same manner, the group message that is received by a group session device also needs to carry the session serial number, such that the group session device obtains a group session corresponding to the received group message.

Corresponding to the above-described method for implementing a group session, the embodiments of the present invention also provide a group session device for implementing the above-described method. As described in FIG. 4, the group session device, including the following:

a sender 401, configured to send a group message to a group session server, the group message carrying a session serial number corresponding to the current message group session; and/or

a receiver 402, configured to receive a group message, which is forwarded by the group session server, sent by other terminal participating in the group session to the group session server, the group message carrying a session serial number corresponding to the current message group session.

According to the method and the group session device for implementing the group session provided according to the embodiments of the present invention, since the group message carries a session serial number, no matter which receives the group message is a group session server or a group session device, after receiving the group message, both the group session server or a group session device are able to determine what is received currently is a group message and obtains the message group session corresponding to the group message. With the above-described solution, a group message is enabled to be transferred via an ordinary communication channel that can be multiplexed by multiple users or multiple sessions without occupying specific media channel, thereby increasing the comprehensive utilization of channels.

### Embodiment 3

In the present embodiment, taking the group message being a CPM/IM short message as an example, the method for implementing a group session provided according to the embodiments of the present invention is described in detail through a complete implementation process of a CPM/IM short message group session.

According to the present embodiment, a CPM/IM user terminal UE1 is taken as an initiating terminal participating in the CPM/IM short message group session, and user terminal UE2 and user terminal UE3 are taken as the terminals participating in the CPM/IM short message group session. Hereinafter a CPM/IM short message group session will be referred to as a short message group session and a group message interacted between different terminals in an ordinary CPM/IM short message group session will be referred to as a group short message.

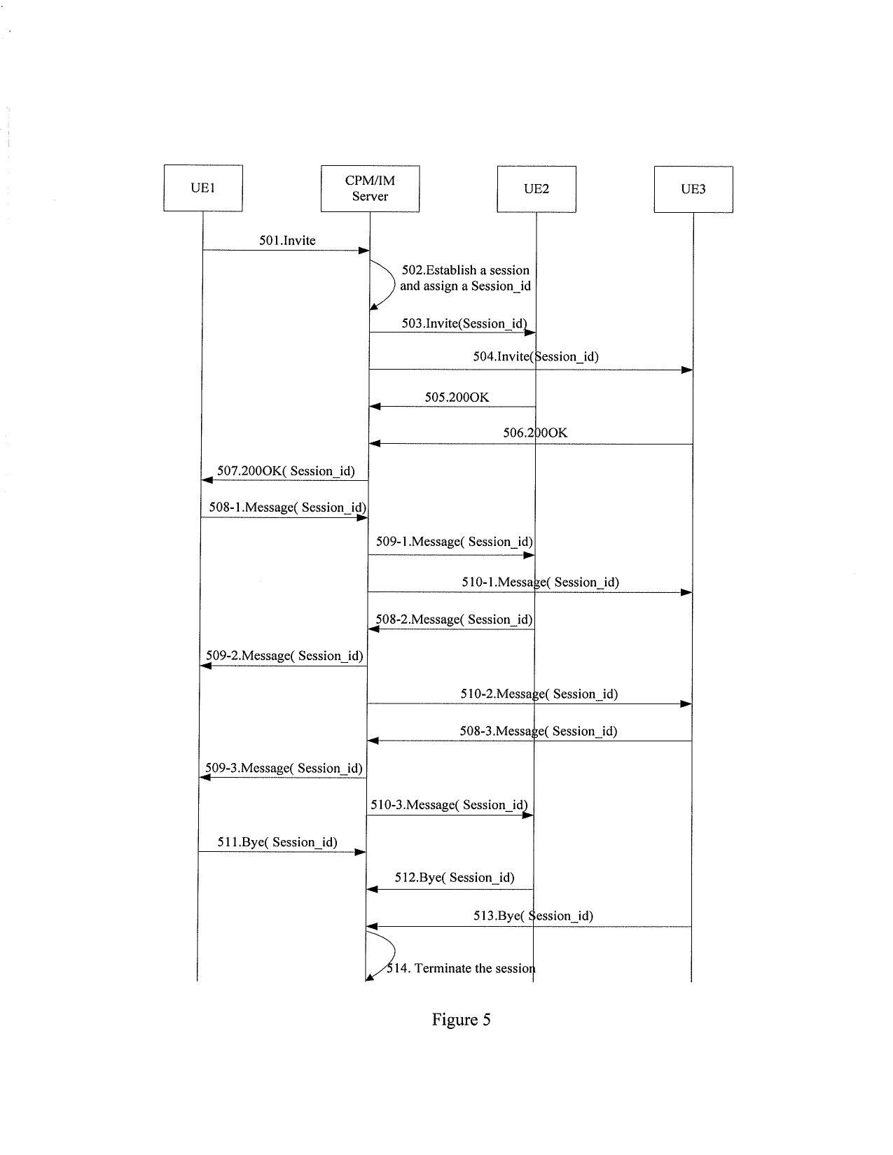

As illustrated in FIG. 5, the method for implementing a group session provided according to the embodiments of the present invention specifically includes the following steps:

501, the terminal UE1 sends, to a CPM/IM short message group session server (refer to as CPM/IM server hereinafter), a request for establishing a short message group session, the request carrying terminal identifications of the terminal UE2 and the terminal UE3 or group identification the terminals UE2 and UE3 belong to.

The request for establishing a short message group session may be Invite signalling. In the present embodiment, however, an identification that indicates requesting establishing a group session based on a CPM/IM short message is added to the Invite signalling.

In order to enable the group session server to clearly obtain all the terminals participating the group session, the request for establishing a short message group session may further carry the terminal identifications participating in the group session or group identification all other terminals participating in the group session except the terminal initiating the group session. The terminal identification may be a equipment identification number of a terminal participating in the group session (such as a phone number) or a URL (Universal Resource Locator) and so on, and the group identification may be a code of a specific group to which a certain terminal participating in the group session belongs.

As the identification that indicates requesting establishing a group session based on CPM/IM short message is added in the Invite message, the Invite message is used to request for establishing a short message group session among UE1, UE2 and UE3.

502, the CPM/IM server establishes a short message group session, and assigns a session serial number, Session_id, for the short message group session.

After reading the identification indicates requesting establishing a CPM/IM short message based on group session in the Invite signalling, the CPM/IM server may know that a session that is needed to be established currently is a CPM/IM short message group session based on Message sigalling bearer rather than a group session based on media channels, i.e., Session session; and meanwhile, the CPM/IM server also assigns a Session_id for the established short message group session so that the short message group session can proceed smoothly in the subsequent processes.

503˜504, the CPM/IM server sends, according to the terminal identification or group identification, a session request to other terminals participating in the group session, i.e., UE2 and UE3, for inviting UE2 and UE3 to participate in the short message group session; and the session request carries the Session_id of the short message group session.

According to the present embodiment, the Session_id is carried by a session request sent from the CPM/IM server to the terminals participating in the group session; however, the manner of the CPM/IM server sending the Session_id to the terminals participating in the group session is not limited to the manner described as the present embodiment, for example, the Session_id can also be transferred by an Info message.

505˜506, UE2 and UE3 accept the invitation to participate in the short message group session, and return session establishing responses 200OK to the CPM/IM server.

507, the CPM/IM server sends, to UE1, a short message group session establishing response 200OK which includes the Session_id of the short message group session.

The CPM/IM server may also transfer the Session_id to UE1 by an Info message in a manner that is similar to the manner in which UE2 and UE3 acquire a Session_id.

508-1, during a normal group session, UE1 sends a group short message which carries the Session_id to the CPM/IM server via Message signalling.

509-1˜510-1, the CPM/IM server determines, according to the Session_id, the short message group session to which the group short message belongs, and sends the group short message, which is from UE1 and carries the Session_id, to other terminals participating in the short message group session corresponding to the Session_id, UE2 and UE3. Therefore, UE2 and UE3 may simultaneously receive the group short message from UE1.

Steps 508-2, 509-2 and 510-2 that are illustrated described as FIG. 5 describe the process of sending a group short message by UE2 to UE1 and UE3 via the CPM/IM server, steps 508-3, 509-3 and 510-3 illustrate the process of sending a group short message by UE3 to UE1 and UE2 via the CPM/IM server, and the specific implementation processes of both of which are similar with that of steps 508-1˜510-1 and will not be described in detail herein.

511˜513, UE1, UE2 and UE3 sends respectively, to the CPM/IM server, a session termination request Bye which carries the Session_id of the short message group session that is requested to be terminated.

514, the CPM/IM server terminates the short message group session corresponding to the Session_id.

As UE1, UE2 and UE3 all send session termination requests to the CPM/IM server, that is, all the terminals participating in the current short message group session request quitting the short message group session, the short message group session can no longer continue, and the CPM/IM server terminates the short message group session and deletes relevant information.

It is to be noted that, however, if steps 511˜513 do not happen simultaneously or one after another, for example, only step 511 occurs, on such occasions, there are still two terminals, UE2 and UE3, that participate in the short message group session, thus the CPM/IM server may continue to keep the short message group session. Generally, as long as a short message group session has at least two terminals participating in the group session, this short message group session can keep going.

According to the present embodiment, the above-described step numbering and the numbering order in FIG. 5 are not used to limit the actual executing order of the respective steps, for example, step 508-2 may be executed concurrently with step 508-1, or be executed before step 508-1.

According to the present embodiment, the group session server establishes, according to the request for establishing a short message group session that is initiated by a terminal participating in the group session, a group session based on CPM/IM short message and assigns a session serial number for group session based on CPM/IM short message, so that in the subsequent session processes, the short message group session can be determined according to the session serial number; therefore, a group message is enabled to be transferred via an ordinary communication channel that can be multiplexed by multiple users or multiple sessions without occupying specific media channel, thereby increasing the comprehensive utilization of channels.

In addition, the solutions described as the embodiments of the present invention implements a CPM/IM short message group session based on Message sigalling bearer. As the CPM/IM short message group session is User Datagram Protocol (UDP) short connection oriented, the utilization of channels can be further improved.

### Embodiment 4

According to the present embodiment, it continues to take the group message being a CPM/IM short message as an example and further introduces a group session processing flow for the occurrence of timeout of a short message, i.e., a processing flow for the situation of the CPM/IM server failing to receive any group short message within a certain time period.

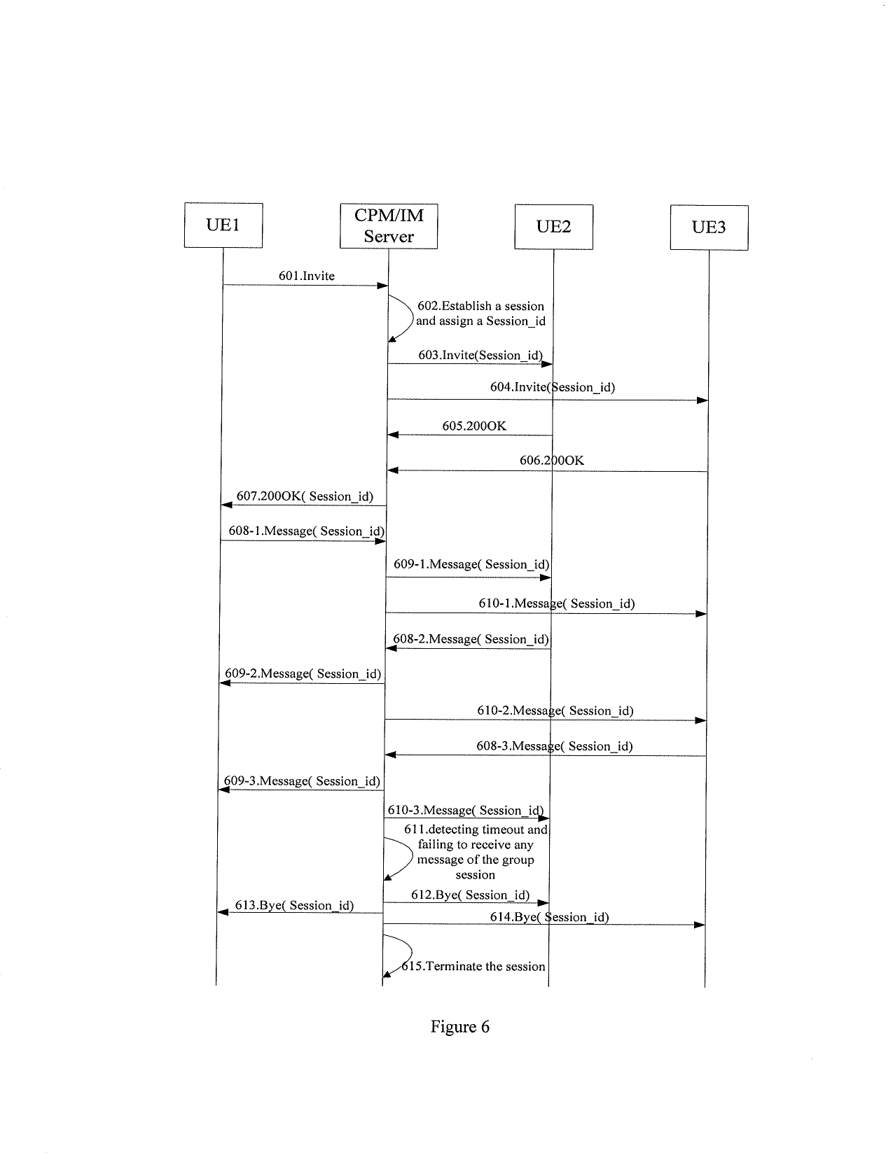

The method for implementing a group session provided according to the embodiments of the present invention, as illustrated in FIG. 6, wherein:

the implementation process of steps 601˜610-3 is essentially the same as that of steps 501˜510-3, and will not be described in detail herein. The subsequent processing steps that relate to the timeout of a short message are introduced in detail hereinafter.

611, after finishing forwarding a latest message, the CPM/IM server detects whether to fail to receive, within a preset period of time, a group short message that is sent by any terminal participating in the current short message group session.

The latest message indicates that the time receiving the latest message by the CPM/IM server is the latest among all the times receiving all the messages by the CPM/IM server.

The preset period of time may be set by those skilled in the art according to experience and be saved in the CPM/IM server, and may also be a fixed time period set by the CPM/IM server by default; and the preset period of time may be 3 minutes, 5 minutes or other periods of time.

Specifically, step 611 may start timing just after the CPM/IM server finishes forwarding a latest message, and if the time reaches the duration of the preset period of time, and the CPM/IM server fails to receive any group short message, step 612 is executed.

612˜614, if failing to receive any group short message within the preset period of time, the CPM/IM server sends, to all the terminals (UE1, UE2 and UE3) participating in the current short message group session, a session termination message Bye which carries the Session_id of the current short message group session.

615, the CPM/IM server terminates the current short message group session and deletes relevant information of the current short message group session.

According to the present embodiment, the group session server establishes, according to the request for establishing a short message group session that is initiated by a terminal participating in the group session, a group session based on CPM/IM short message and assigns a session serial number for the group session based on CPM/IM short message; if the CPM/IM server fails to receive any group short message within a certain time period, the group session server is also able to terminate the corresponding short message group session according to the session serial number so as to reduce the waste of channel resources and further improve the utilization of communication channels.

### Embodiment 5

According to the present embodiment, an implementation process of performing a short message group session between two terminals participating in the group session, UE1 and UE2, will be introduced by taking the group message being a CPM/IM short message as an example, wherein UE1 is the terminal initiating the CPM/IM short message group session.

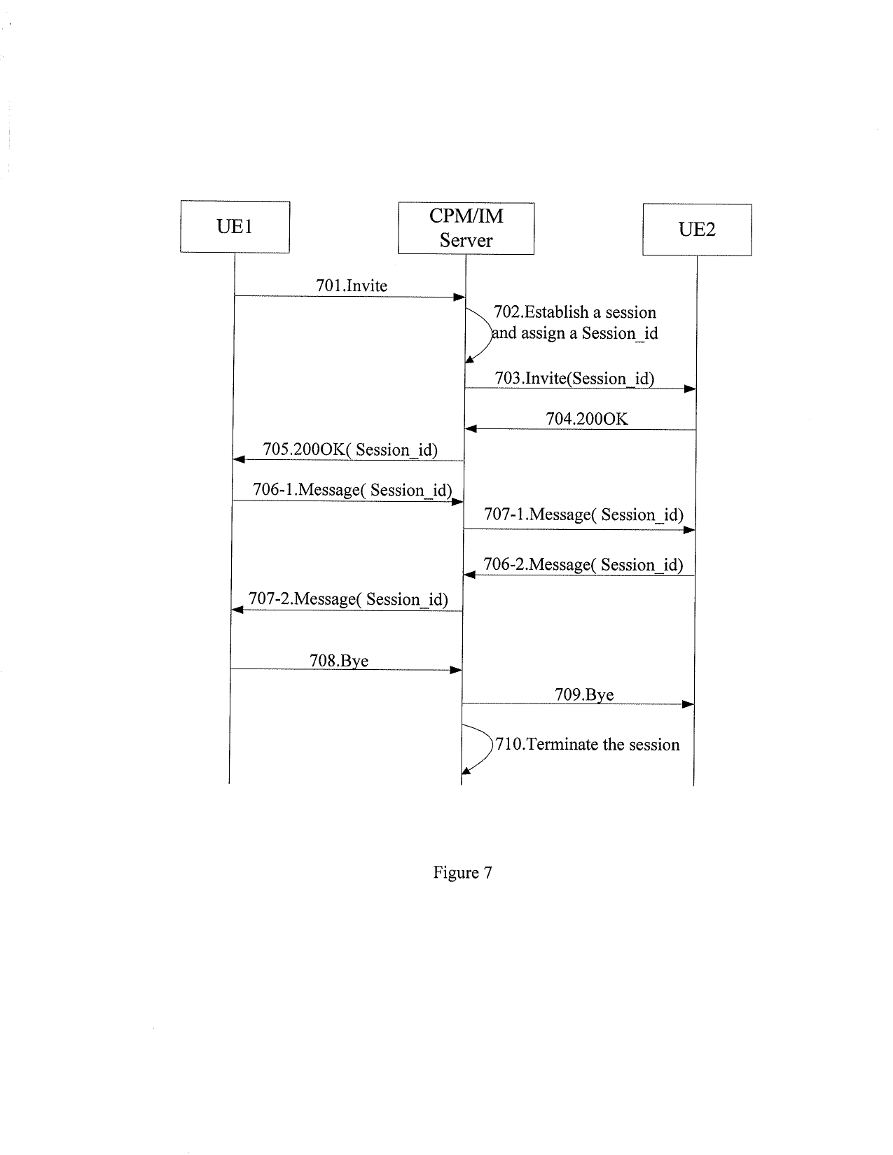

Specifically, as described in FIG. 7, the method for implementing a group session provided according to the embodiments of the present invention includes the following steps:

701, terminal UE1 sends an Invite message which carries the terminal identification of UE2 or group identification to the UE2 belongs to a CPM/IM server.

Since the identification which indicates requesting establishing a group session based on CPM/IM short message is added in the Invite message, the Invite message may be used to request establishing a short message group session between UE1 and UE2.

702, the CPM/IM server establishes the short message group session, and assigns a session serial number Session_id for the short message group session.

703, the CPM/IM server sends, according to the terminal identification carried in the Invite message or group identification carried in the Invite message, a session request to other terminal UE2 participating in the group session for inviting UE2 to participate in the short message group session; and the session request carries the Session_id of the short message group session.

According to the present embodiment, the Session_id is carried by a session request sent by the CPM/IM server to terminals participating in the group session; however, the manner of the CPM/IM server sending the Session_id to the terminals participating in the group session is not limited to the manner in that the Session_id is carried by a session request sent by the CPM/IM server to terminals participating in the group session, for example, the Session_id may also be transferred by an Info message.

704, UE2 accepts the invitation to participate in the short message group session, and returns a session establishing response 200OK to the CPM/IM server.

705, the CPM/IM server sends, to UE1, a short message group session establishing response 200OK which includes the Session_id of the short message group session.

The CPM/IM server may also transfer the Session_id to UE1 by an Info message in a manner that is similar to the manner in which UE2 acquires a Session_id.

706-1, during a normal group session, UE1 sends a group short message which carries the Session_id to the CPM/IM server via Message signalling.

707-1, the CPM/IM server determines the short message group session to which the group short message belongs according to the Session_id, and sends the group short message, which is from UE1 and carries the Session_id, to other terminal UE2 participating in the short message group session that corresponds to the Session_id.

Steps 706-2 and 707-2 that are illustrated in FIG. 7 describe the process of sending a group short message by UE2 to UE1 via the CPM/IM server, the specific implementation process of which is similar with that of steps 706-1˜707-1 and will not be described in detail herein.

When one party of the short message group session request quitting the current group session, besides utilizing a method that is similar with steps 511˜513 in Embodiment 3, it can also be realized in the following way:

708, UE1 sends, to the CPM/IM server, a session termination request Bye, which carries the Session_id of the short message group session that is requested to be terminated or the terminal identification of UE1.

709, after receiving the session termination request from UE1, the CPM/IM server sends a session termination message Bye to UE2.

The session termination message includes the Session_id for informing UE2 of the short message group session that is to be terminated; or the session termination message includes the terminal identification of UE1 for informing UE2 of terminating the group session with UE1.

710, the CPM/IM server terminates the current short message group session.

On the occasion that there are only two terminals participating in a certain short message group session, once one terminal quits, the short message group session can no longer continue, so the termination flow of the short message group session in which there are only two terminals participating is a little different from that in Embodiment 3.

According to the present embodiment, the method for implementing a group session provided by the embodiments of the present invention is introduced by taking the short message group session between two terminals as an example. With the solution according to the present embodiment, the group session server establishes, according to the request for establishing a short message group session that is initiated by a terminal participating in the group session, a group session based on CPM/IM short message and assigns a session serial number for the group session based on CPM/IM short message, which enables the subsequent session processes to determine the short message group session according to the session serial number; therefore, a group message is enabled to be transferred via an ordinary communication channel that can be multiplexed by multiple users or multiple sessions without occupying specific media channel, thereby increasing the comprehensive utilization of channels.

In addition, the solution according to the embodiments of the present invention accomplishes a CPM/IM short message group session based on Message sigalling bearer. As the CPM/IM short message group session is User Datagram Protocol (UDP) short connection oriented, the utilization of channels can be further improved.

### Embodiment 6

According to the present embodiment, taking the group message being a group session message of Internet of Things M2M as an example, the method for implementing a group session provided by the embodiments of the present invention is described in detail through an implementation process of a specific Internet of Things M2M group session.

According to the present embodiment, taking a M2M service application device as the terminal initiating the Internet of Things M2M group session, M2M sensor device 1 or device gateway 1 and M2M sensor device 2 or device gateway 2 as the terminals participating in the Internet of Things M2M group session.

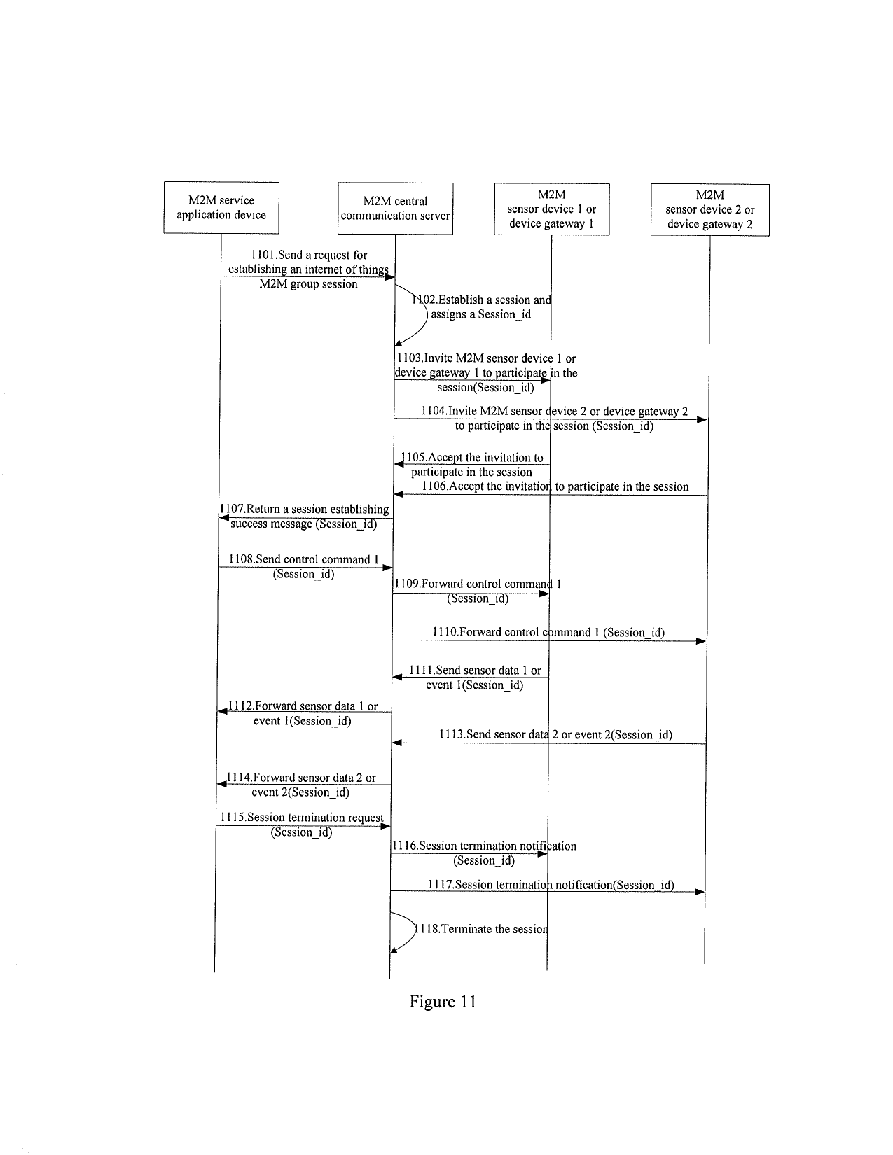

As described in FIG. 11, the method for implementing a group session provided according to the embodiments of the present invention specifically includes the following steps:

1101, the M2M service application device sends, to an M2M central communication server, a request for establishing an Internet of Things M2M group session, and the request carries at least one of a device identification of the M2M sensor device 1 or a gateway identification of the M2M sensor device 1 or a device identification of the device gateway 1 or a gateway identification of device gateway 1, and a device identification of the M2M sensor device 2 or a gateway identification of the M2M sensor device 2 or a device identification of the device gateway 2 or a gateway identification of device gateway 2.

The M2M service application device may be an M2M service application server, and also may be an M2M service application terminal.

1102, the M2M central communication server establishes an Internet of Things M2M group session, and assigns a session serial number Session_id for the Internet of Things M2M group session so that the group session can proceed smoothly in the subsequent processes.

1103˜1104, the M2M central communication server sends, according to the device identification carried in the request or the gateway identification carried in the request, a session request to other terminals participating in the group session, i.e., any one of the M2M sensor device 1 and the device gateway 1 and any one of the M2M sensor device 2 and the device gateway 2, for inviting any one of the M2M sensor device 1 and the device gateway 1 and any one of the M2M sensor device 2 and the device gateway 2 to participate in the Internet of Things M2M group session; and the session request carries the Session_id of the Internet of Things M2M group session.

1105˜1106, any one of the M2M sensor device 1 and the device gateway 1 and any one of the M2M sensor device 2 the device gateway 2 accept the invitation to participate in the Internet of Things M2M group session, and return responses of accepting the invitation to participate in the Internet of Things M2M group session to the M2M central communication server.

1107, the M2M central communication server returns, to the M2M service application device, an establishing session success message which carries the Session_id of the Internet of Things M2M group session.

1108, the M2M service application device sends, to the M2M central communication server, control command 1 which carries the Session_id of the Internet of Things M2M group session.

1109˜1110, the M2M central communication server forwards control command 1 which carries the Session_id of the Internet of Things M2M group session to any one of the M2M sensor device 1 and the device gateway 1 and any one of the M2M sensor device 2 and the device gateway 2.

At the moment of receiving the control command 1, the M2M central communication server also obtains the Session_id of the Internet of Things M2M group session, and thus forwards the control command 1 to other terminals participating in the Internet of Things M2M group session, i.e., any one of the M2M sensor device 1 and the device gateway 1 and any one of the M2M sensor device 2 and the device gateway 2.

1111, any one of the M2M sensor device 1 and the device gateway 1 returns a sensor data 1 which carries the Session_id of the Internet of Things M2M group session and/or an event 1 message which carries the Session_id of the Internet of Things M2M group session to the M2M central communication server.

1112, the M2M central communication server forwards, according to the Session_id, the received sensor data 1 and/or the received event 1 message to the terminal initiating the Internet of Things M2M group session, i.e., to the M2M service application device.

1113, any one of the M2M sensor device 2 and device gateway 2 returns a sensor data 2 which carries the Session_id of the Internet of Things M2M group session and/or an event 2 message which carries the Session_id of the Internet of Things M2M group session to the M2M central communication server.

1114, the M2M central communication server forwards, according to the Session_id, the received sensor data 2 and/or the received event 2 message to the terminal initiating the Internet of Things M2M group session, i.e., to the M2M service application device.

If the M2M service application device needs to continue sending other control messages to other terminals participating in the Internet of Things M2M group session, steps 1108˜1114 are repeatedly executed; if there is no need to continue sending control messages, step 1115 may be executed.

1115, the M2M service application device sends a session termination request which carries the Session_id of the Internet of Things M2M group session to the M2M central communication server.

1116˜1117, the M2M central communication server sends, according to the Session_id, a session termination notification to other terminals participating in the Internet of Things M2M group session, i.e., to any one of the M2M sensor device 1 and the device gateway 1 and any one of the M2M sensor device 2 and the device gateway 2.

1118, the M2M central communication server deletes the Internet of Things M2M group session corresponding to the Session_id and releases the Session_id of the Internet of Things M2M group session.

According to the present embodiment, the method for implementing a group session provided by the embodiments of the present invention is introduced by taking the group session between an M2M service application device and multiple M2M sensor devices or device gateways as an example. With the solution in the present embodiment, the M2M central communication server establishes an Internet of Things M2M group session according to the request for establishing a message group session that is initiated by the M2M service application device, and assigns a session serial number for the Internet of Things M2M group session, which enables the subsequent session processes to determines the Internet of Things M2M group session according to the session serial number.

### Embodiment 7

According to the present embodiment, taking the group message being a group session message of Internet of Things M2M as an example, the method for implementing a group session provided by the embodiments of the present invention is described in detail through an implementation process of an Internet of Things M2M group session between two terminals participating in the group session.

According to the present embodiment, take an M2M service application device as the terminal initiating the Internet of Things M2M group session, and take an M2M sensor device or a device gateway as the participating terminal of the Internet of Things M2M group session.

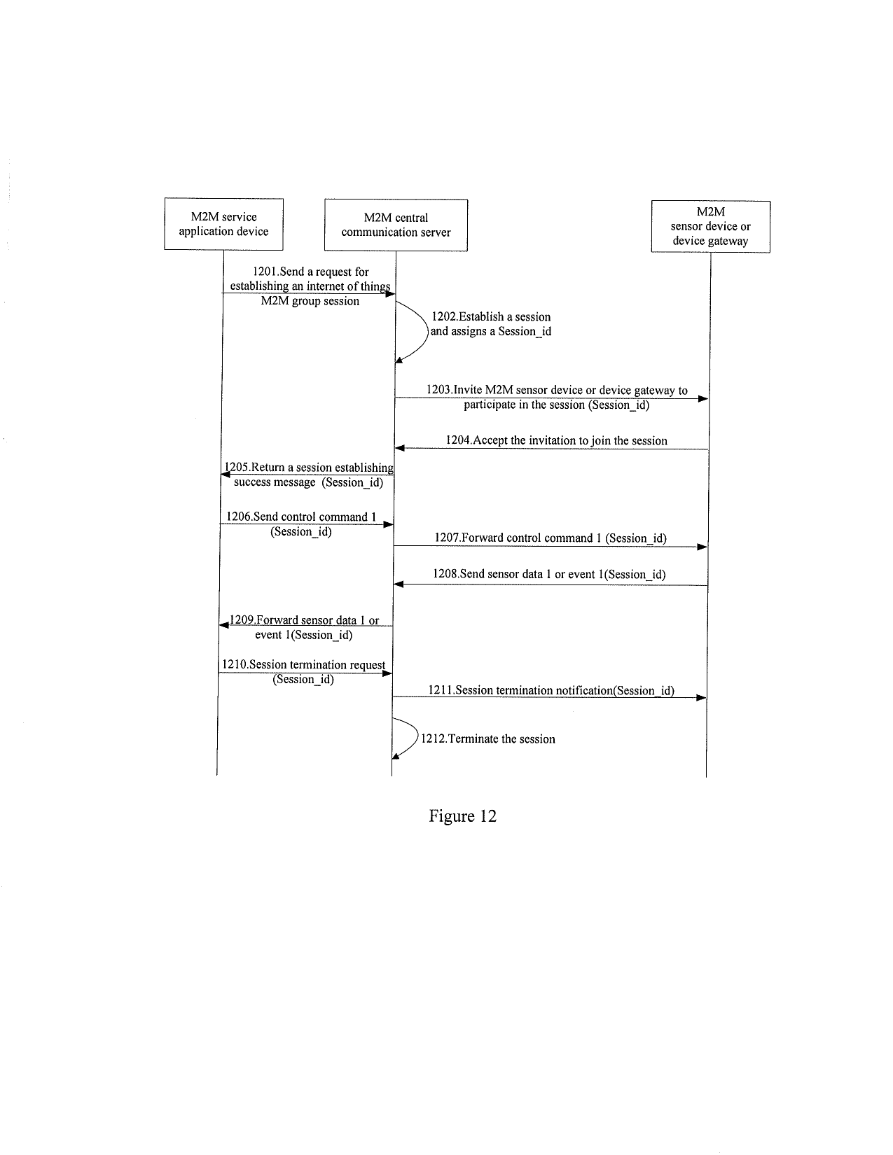

As described in FIG. 12, the method for implementing a group session provided according to the embodiments of the present invention specifically includes the following steps:

1201, the M2M service application device sends, to an M2M central communication server, a request for establishing an Internet of Things M2M group session, wherein the request carries a device identification of the M2M sensor or a gateway identification of the M2M sensor device or a device identification of the device gateway or a gateway identification of the device gateway.

The M2M service application device may be an M2M service application server, and also may be an M2M service application terminal.

1202, the M2M central communication server establishes an Internet of Things M2M group session, and assigns a session serial number Session_id for the Internet of Things M2M group session so that the group session can proceed smoothly in the subsequent processes.

1203, the M2M central communication server sends, according to the device identification carried in the request or the gateway identification carried in the request, a session request to other terminal participating in the group session, i.e., to the M2M sensor device or the device gateway, for inviting the M2M sensor device or device gateway to participate in the Internet of Things M2M group session; the session request carries the Session_id of the Internet of Things M2M group session.

1204, any one of the M2M sensor device and the device gateway accepts the invitation to participate in the Internet of Things M2M group session, and returns a response of accepting the invitation to participate in the session to the M2M central communication server.

1205, the M2M central communication server returns, to the M2M service application device, a session establishing success message which carries the Session_id of the Internet of Things M2M group session.

1206, the M2M service application device sends control command 1 which carries the Session_id of the Internet of Things M2M group session to the M2M central communication server.

1207, the M2M central communication server forwards the control command 1 which carries the Session_id of the Internet of Things M2M group session to any one of the M2M sensor device and the device gateway.

At the moment of receiving the control command 1, the M2M central communication server also obtains the Session_id of the Internet of Things M2M group session, and thus forwards the control command 1 to other terminal participating in the Internet of Things M2M group session, i.e., to any one of the M2M sensor device and the device gateway.

1208, any one of the M2M sensor device and the device gateway returns a sensor data 1 which carries the Session_id of the Internet of Things M2M group session and/or an event 1 message which carries the Session_id of the Internet of Things M2M group session to the M2M central communication server.

1209, the M2M central communication server forwards, according to the Session_id, the received sensor data 1 and/or the received event 1 message to the terminal initiating the Internet of Things M2M group session, i.e., to the M2M service application device.

If the M2M service application device needs to continue sending other control messages to other terminals participating in the Internet of Things M2M group session, steps 1206˜1209 may be repeatedly executed; if there is no need to continue sending control messages, step 1210 may be executed.

1210, the M2M service application device sends a session termination request which carries the Session_id of the Internet of Things M2M group session to the M2M central communication server.

1211, the M2M central communication server sends, according to the Session_id, a session termination notification to other terminal participating in the Internet of Things M2M group session, i.e., to any one of the M2M sensor device and the device gateway.

1212, the M2M central communication server deletes the Internet of Things M2M group session corresponding to the Session_id and releases the Session_id of the Internet of Things M2M group session.

According to the present embodiment, the method for implementing a group session provided by the embodiments of the present invention is introduced by taking the group session between an M2M service application device and any one of the M2M sensor device and the device gateway as an example. With the solution according the present embodiment, the M2M central communication server establishes an Internet of Things M2M group session according to the request for establishing a message group session initiated by the M2M service application device, and assigns a session serial number for the Internet of Things M2M group session, which enables the subsequent session processes to determine the Internet of Things M2M group session according to the session serial number.

### Embodiment 8

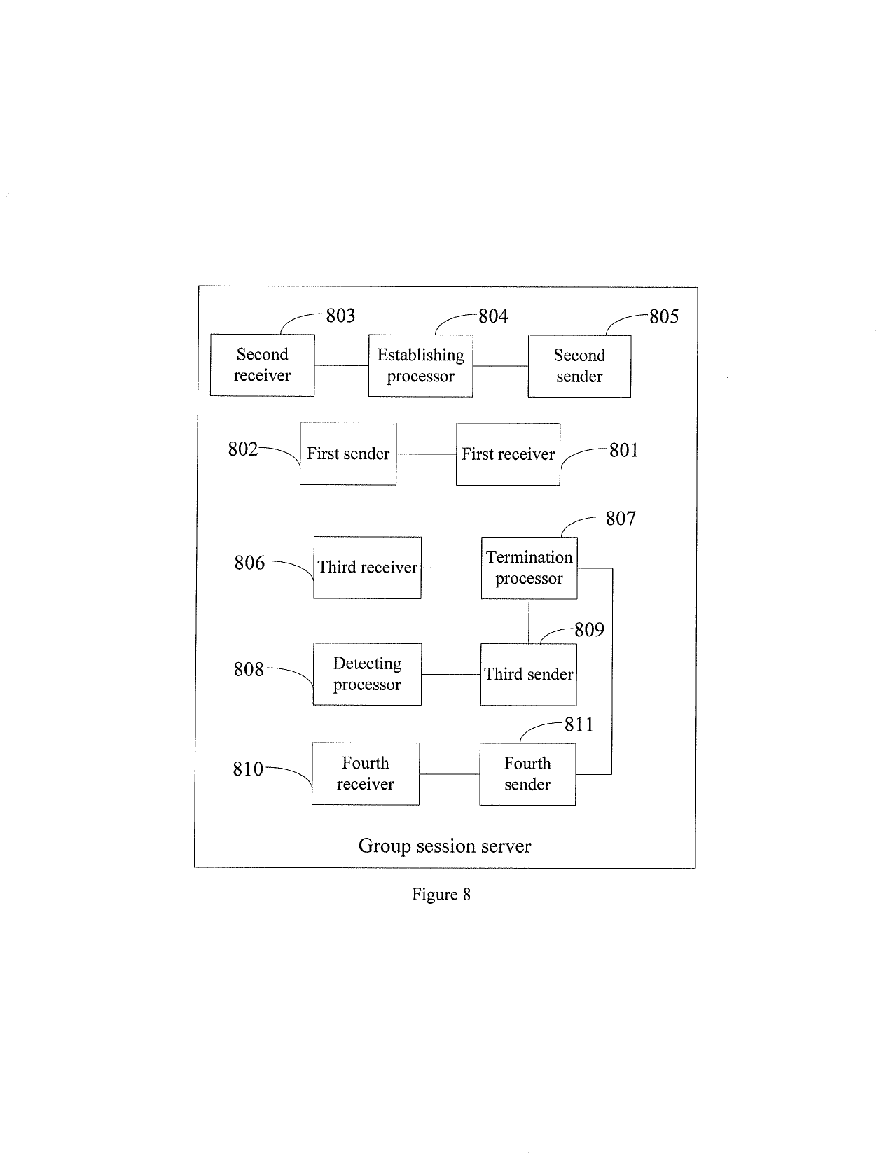

Corresponding to the above-mentioned embodiments of a method, the embodiments of the present invention provide a group session server; specifically, as described in FIG. 8, the group session server according to the present embodiment includes: a first receiver 801 and a first sender 802; wherein,

the first receiver 801, configured to receive a group message that is sent by a certain terminal participating in a message group session, the group message carrying a session serial number corresponding to the message group session; the group message may, but not limited to, be a CPM/IM message, a group session message of Internet of Things M2M, a group session message based on voice or a group session message based on multimedia and the like, and the CPM/IM message may further be a CPM/IM short message based on signalling;

the first sender 802, configured to send the group message which carries the session serial number to other terminals participating in the message group session corresponding to the session serial number.

Further, the group session server according to the present embodiment may also include:

a second receiver 803, configured to receive a request for establishing a message group session from a certain group session device;

an establishing processor 804, configured to establish a message group session and assign a session serial number for the message group session; and

a second sender 805, configured to send the session serial number to all the terminals participating in the message group session.

After finishing a group session between multiple terminals participating in the message group session, the participating terminals initiate a message group session termination flow on their own initiative. In order to accomplish this process, the group session server is also needed to include:

a third receiver 806, configured to receive session termination requests that are sent by all the terminals participating in the message group session, the session termination requests carrying the session serial number; and

a termination processor 807, configured to terminate the message group session corresponding to the session serial number.

If the situation of failing to receive any group short message within a certain time period occurs, the group session server is needed to initiate the flow of terminating the message group session on its own initiative; in this case, the group session server also includes:

a detecting processor 808, configured to detect whether to fail to receive any group short message that is sent by one terminal participating in the current short message group session within a preset period of time;

a third sender 809, configured to, when the detecting result of the detecting processor 808 is failing to receive any group short message that is sent by one terminal participating in the current short message group session within a preset period of time, send a session termination message to all the terminals participating in the current message group session, the session termination message carrying the session serial number of the current message group session; and

a termination processor 807 configured to terminate the current message group session.

If there are only two terminals participating in the message group session, under this condition, the group session server may has the following implementing method, that is, on the basis of the above-described group session server, may also include:

a fourth receiver 810, configured to receive a session termination request that is sent by a first terminal participating in the message group session, the session termination request carrying the session serial number of the current message group session or the device identification of the first terminal participating in a message group session;

a fourth sender 811, configured to send, to a second terminal participating in the current message group session, a session termination message which carries the session serial number of the current message group session or the device identification of the first terminal participating in a message group session; and

a termination processor 807, configured to terminate the current message group session.

The specific manner of working of the group session server in the present embodiment can refer to the description according to the preceding embodiments of a method and won't be described in detail herein.

With the group session server according to the present embodiment, a received message is enabled to be determined as a group message according to the session serial number carried in the message, and the group message is forwarded to other terminals participating in the current message group session simultaneously; with the above-described solution, a group message is enabled to be transferred via an ordinary communication channel that can be multiplexed by multiple users or multiple sessions without occupying specific media channel, thereby increasing the comprehensive utilization of channels.

### Embodiment 9

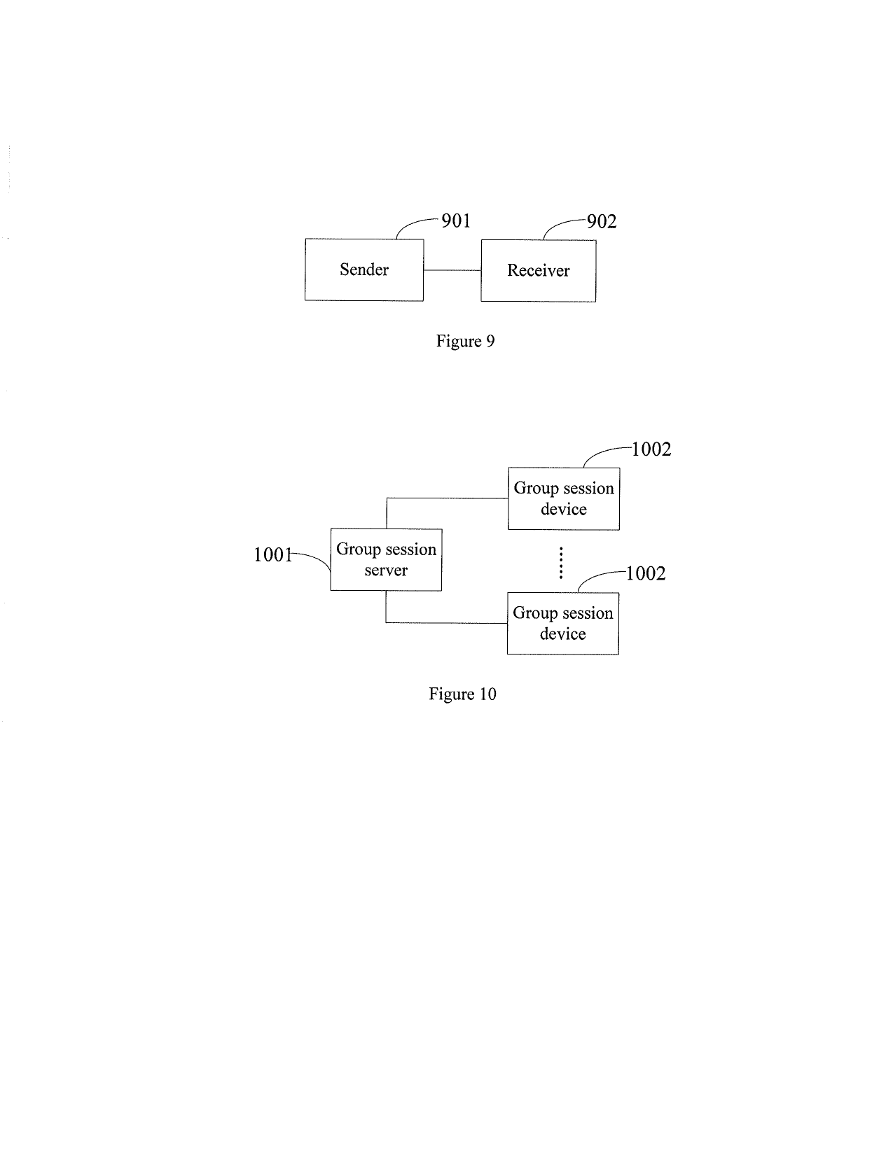

Corresponding to the above-mentioned embodiments of a method, the embodiments of the present invention provide a group session device; specifically, as illustrated in FIG. 9, the group session device in the present embodiment includes: a sender 901 and/or a receiver 902; wherein,

the sender 901, configured to send a group message to a group session server, the group message carrying a session serial number corresponding to the current message group session; and

the receiver 902, configured to receive a group message, which is forwarded by the group session server, from other terminals participating in a message group session, the group message carrying a session serial number corresponding to the current message group session;

wherein the group session may, but not limited to, be a CPM/IM message, a group session message of Internet of Things M2M, a group session message based on voice or a group session message based on multimedia and the like; wherein the ordinary CPM/IM group session message may be a text message or a voice message, and the group session based on voice may be an ordinary voice conversation session or a POC session and the like.

Further, the CPM/IM message may be a CPM/IM short message based on signalling.

Further, the receiver 902 is also configured to receive a session serial number that is issued by the group session server.

With the group session device provided according to the present embodiment, after receiving a message, the currently received message is enabled to be determined, according to the carried session serial number thereof, as a group message and the message group session to which the group message belongs; with the above-described solution, a group message is enabled to be transferred via an ordinary communication channel that can be multiplexed by multiple users or multiple sessions without occupying specific media channel, thereby increasing the comprehensive utilization of channels.

### Embodiment 10

The embodiments of the present invention also provide a group session system, as shown in FIG. 10, the group session system includes: a group session server 1001 and at least two group session devices 1002; wherein,

the group session device 1002, configured to send a group message which carries a session serial number corresponding to the current message group session to the group session server 1001; the group message may, but not limited to, be a CPM/IM message, a group session message of Internet of Things M2M, a group session message based on voice or a group session message based on multimedia and the like;

the group session server 1001, configured to receive a group message that carries the session serial number, and sending the group message to other group session devices of the message group session corresponding to the session serial number.

In addition, according to the present embodiment, the group session device 1002 is also configured to receive the group message, which is forwarded by the group session server 1001, from other terminals participating in a message group session, the group message carrying the session serial number corresponding to the current message group session.

In the group session system provided in the embodiments of the present invention, the group message carries a session serial number, no matter it is a group session server which receives the group message or a group session device which receives the group message, after receiving the group message, both of them are able to determine the currently received message is a group message and the message group session to which the group message belongs; with the above-described solution, a group message is enabled to be transferred via an ordinary communication channel that can be multiplexed by multiple users or multiple sessions without occupying specific media channel, thereby increasing the comprehensive utilization of channels.

According to the solutions provided by the embodiments of the present invention, the channels (signalling channels or media data channels) that carry a group message implement a message transferring manner that can be multiplexed by multiple users or multiple sessions through carrying a Session_id in the group message, such that the signalling or data media channel resources can also be multiplexed by multiple users or multiple sessions under cloud computing environment in the future.

The specific process of the device, server and system, which are used to execute the method described by the embodiments of the present invention, executing the method of the present invention may refer to the relevant description of the embodiments of the method and will not be described in detail herein.

With the preceding description of the implementation methods, those skilled in the art can clearly appreciated that the present invention may be accomplished by means of software with necessary hardware platform, certainly may also be accomplished by hardware. Based on the understanding, all or part of the contribution of the technical solution of the present invention to the background technologies can be embodied in the form of a software product, and the software product can be stored in a storage medium such as ROM/RAM, disk, CD and the like, including various of commands that enable a computer device (may be personal computer, server or network device and so on) to execute the method that is described in the respective embodiments or some parts of the embodiments.

The foregoing description is only the specific implementation method of the present invention, rather than the limits of the protection scope of the present invention, any change or alteration that can be readily thought of by those skilled in the art within the disclosed technologies of the present invention falls into the protection scope of the present invention. As a result, the protection scope of the present invention shall be determined according to claims.

1. A method for implementing a group session, comprising:
receiving a group message that is sent by a terminal participating in a message group session, wherein the group message carries a session serial number corresponding to the message group session; and
sending the group message carrying the session serial number to other terminals participating in the message group session corresponding to the session serial number.

2. The method of claim 1, wherein the group message is one of an Internet of Things M2M group session message, an IP based CPM/IM message or a group session message based on voice, a group session message based on multimedia.

3. The method of claim 2, wherein the CPM/IM message is a CPM/IM short message based on sigalling bearer.

4. The method of claim 1, before receiving a group message that is sent by the terminal participating in a message group session, further comprising:
receiving a request for establishing the message group session;
establishing the message group session and assigning the session serial number for the message group session; and
sending the session serial number to all the terminals participating in the message group session.

5. The method of claim 1, further comprising:
receiving session termination requests that are sent by all the terminals participating in the message group session, wherein the session termination requests carry the session serial number; and
terminating the message group session corresponding to the session serial number.

6. The method of claim 1, further comprising:
detecting whether to fail to receive, within a preset period of time, any group message that is sent by any one of all the terminals participating in the current message group session;
sending a session termination message to all the terminals participating in the current message group session if failing to receive any group message within the preset period of time, wherein the session termination message carries the session serial number corresponding to the current message group session; and
terminating the current message group session.

7. The method of claim 4, further comprising:
detecting whether to fail to receive, within a preset period of time, any group message that is sent by any one of the terminals participating in the current message group session;
sending a session termination message to all the terminals participating in the current message group session if failing to receive any group message within the preset period of time, wherein the session termination message carries the session serial number corresponding to the current message group session; and
terminating the current message group session.

8. The method of claim 1, further comprising:
receiving a session termination request sent by any one terminal participating in the group session, wherein the session termination request carries the session serial number corresponding to the message group session or a device identification of the any one terminal participating in the group session;
sending, to other terminals participating in the current message group session except the any one terminal participating in the group session, a session termination message that carries the session serial number corresponding to the current message group session or the device identification of the any one terminal participating in the group session; and
terminating the current message group session.

9. The method of claim 4, further comprising:
receiving a session termination request sent by any one terminal participating in the group session, wherein the session termination request carries the session serial number corresponding to the message group session or a device identification of the any one terminal participating in the group session;
sending, to other terminals participating in the current message group session except the any one terminal participating in the group session, a session termination message that carries the session serial number corresponding to the current message group session or the device identification of the any one terminal participating in the group session; and
terminating the current message group session.

10. A method for implementing a group session, comprising at least one of:
sending a group message to a group session server, the group message carrying a session serial number corresponding to a current message group session; and
receiving an another group message, which is forwarded by the group session server, from other terminals participating in the group session, the another group message carrying the session serial number corresponding to the current message group session.

11. The method of claim 10, further comprising:
receiving a session serial number that is issued by the group session server.

12. A group session server, comprising:
a first receiver, configured to receive a group message that is sent by a terminal participating in a message group session, the group message carrying a session serial number corresponding to the message group session; and
a first sender, configured to send the group message which carries the session serial number to other terminals participating in the message group session corresponding to the session serial number.

13. The group session server of claim 12, further comprising:
a second receiver, configured to receive a request for establishing a message group session;
an establishing processor, configured to establish a message group session and assign a session serial number for the message group session; and
a second sender, configured to send the session serial number to all the terminals participating in the message group session.

14. The group session server of claim 12, further comprising:
a third receiver, configured to receive session termination requests that are sent by all the terminals participating in the message group session, the session termination requests carrying the session serial number; and
a termination processor, configured to terminate the message group session corresponding to the session serial number.

15. The group session server of claim 13, further comprising:
a third receiver, configured to receive session termination requests that are sent by all the terminals participating in the message group session, the session termination requests carrying the session serial number; and
a termination processor, configured to terminate the message group session corresponding to the session serial number.

16. The group session server of claim 12, further comprising:
a detecting processor, configured to detect whether to fail to receive, within a preset period of time, any group message that is sent by any one terminal participating in the current message group session;
a third sender, configured to send a session termination message to all the terminals participating in the current message group session if failing to receive the any group message within the preset period of time, the session termination message carrying the session serial number of the current message group session; and
a termination processor, configured to terminate the current message group session.

17. The group session server of claim 13, further comprising:
a detecting processor, configured to detect whether to fail to receive, within a preset period of time, any group message that is sent by any one terminal participating in the current message group session;
a third sender, configured to send a session termination message to all the terminals participating in the current message group session if failing to receive the any group message within the preset period of time, the session termination message carrying the session serial number of the current message group session; and
a termination processor, configured to terminate the current message group session.

18. The group session server of claim 12, further comprising:
a fourth receiver, configured to receive a session termination request sent by any one terminal participating in the group session, the session termination request carrying the session serial number corresponding to the current message group session or the device identification of the any one terminal participating in the group session;
a fourth sender, configured to send, to other terminals participating in the current message group session, a session termination message that carries the session serial number corresponding to the current message group session or the device identification of the any terminal participating in the group session; and
a termination processor, configured to terminate the current message group session.

19. A group session device, comprising:
a sender, configured to send a group message to a group session server, the group message carrying a session serial number corresponding to the current message group session; and/or
a receiver, configured to receive a group message, which is forwarded by the group session server, from other terminals participating in the group session, the group message carrying the session serial number corresponding to the current message group session.

20. The group session device of claim 19, wherein the receiver is further configured to receive a session serial number that is issued by the group session server.
